(19) United States
(12) Patent Application Publication
(10) Pub. No.: US 2014/0278596 A1
(43) Pub. Date: Sep. 18, 2014

(54) ADAPTIVE RESERVATION PROCESSING

(71) Applicants: Jonathan Daniel Cordero, Orlando, FL (US); Robert Raymond Cooke, Lake Mary, FL (US); Ezekiel Brooks, Windermere, FL (US)

(72) Inventors: Jonathan Daniel Cordero, Orlando, FL (US); Robert Raymond Cooke, Lake Mary, FL (US); Ezekiel Brooks, Windermere, FL (US)

(21) Appl. No.: 13/836,786

(22) Filed: Mar. 15, 2013

(51) Int. Cl. G06Q 10/02

(52) U.S. Cl. CPC G06Q 10/02; G06Q 30/0207
USPC 705/5

(57) ABSTRACT

Techniques for adaptive reservation processing are provided. Policies define trigger events when a customer's travel plans are being disrupted in some manner that would warrant an incentive from an enterprise associated with those plans. Custom rules are automatically applied to the circumstances surrounding the disruption and a list of incentives is presented for selection by the customer.

### BACKGROUND

Most consumers that travel are at one time or another faced with challenges in getting to their destinations. This is particularly true with airline travel, although it can also be true with other forms of travel such as train, bus, boat, and the like.

In fact, the frequency of travel disruptions is on the rise in large part because the airlines have elected to reduce redundant routes and pack their planes to capacity and in some cases beyond capacity (overbooking). This is good for profitability but bad for customer convenience because when a maintenance or weather issue arises trying to rebook customers on other flights because a real challenge when most if not all of those other flights are already at capacity. Airlines attempt to alleviate the frustration of customers via some form of compensation or by incentivizing the customers with offers or rewards.

So, when travel disruptions occur (such as delayed and canceled flights), passengers often have to work with airline staff to attempt to resolve their disruption efficiently (the process is often referred to as “re-accommodation”). In order to encourage passengers to accept a particular re-accommodation, airlines may incentivize some travel plans; particularly in cases where the passenger is severely disrupted.

But, many passengers would prefer to be presented with options on how they can be re-accommodated and incentivized in a manner that is of most valuable to them. Still further, the airlines would prefer to provide incentives that may turn out to be less costly to them than the standard re-accommodation offers that are uniformly made as a matter of airline policy.

### SUMMARY

In various embodiments, techniques for adaptive reservation processing are presented. According to an embodiment, a method for adaptive reservation processing is provided.

Specifically, an event is detecting indicating a travel disruption to a customer of an enterprise has occurred. Next, rules are automatically applied in view of the event to generate a list of incentive options to re-accommodate the customer with the travel disruption. Finally, the list is directly or indirectly communicated to the customer for selecting one or more of the incentive options from the list.

### BRIEF DESCRIPTION OF THE DRAWINGS

FIG. 1 is a diagram of a method for adaptive reservation processing, according to an example embodiment.

FIG. 2 is a diagram of another method for adaptive reservation processing, according to an example embodiment.

FIG. 3 is a diagram of an adaptive reservation system, according to an example embodiment.

### DETAILED DESCRIPTION

FIG. 1 is a diagram of a method 100 for adaptive reservation processing, according to an example embodiment. The method 100 (hereinafter “incentivize manager”) is implemented as instructions programmed and residing within memory and/or on a non-transitory computer-readable (processor-readable) storage medium and executed by one or more processors, server, web-based Internet portal, cloud, virtual machine (VM), etc.) over a network connection. The processors are specifically configured and programmed to process the incentivize manager. The incentivize manager may also operate over a network. The network is wired, wireless, or a combination of wired and wireless.

Initially and as some context, example situations covered by the techniques presented herein and example features available by the techniques presented herein are presented for illustration and comprehension.

The entities provided herein or other third-party systems can provide for the maintenance of a registry for alternative service providers to use in pursuing accommodations and inconvenience rewards (e.g. incentives for accepting alternate arrangements). The techniques use a combination of current and alternative service providers as defined by class and category.

A rules engine and other instruments of the techniques herein can read a script for instructions on how to respond to specific reservation triggers, such as cancelled flights, delayed flights, customer preferences, and Special Service Requests (e.g. infants, disabilities, medical conditions).

Upon seeing such triggers, the techniques offer the customer several alternative arrangements along with incentives or compensations as defined by the customer.

An example situation includes a case where a customer's flight is completely disrupted by weather. Various techniques herein can notify the customer that arrangements have been disrupted due to weather and/or overbooking (not current example but could be another scenario). The techniques then give the customer multiple options based on applied custom rules and vendor/provider availability for compensatory awards/incentives.

The techniques herein seek to leverage communication capabilities with third-party service providers/vendors in order to provide more intelligent re-accommodation and more appropriate customer-driven incentives.

As another example, consider that space on an earlier and nearly full flight may not be as incentivized as space on a later flight with more available seating. The airline (enterprise) may over incentivize the later flight to ensure better profitability and to avoid further customer travel disruption in the event the customer cannot get on the earlier flight.

The techniques work by analyzing passenger profile information in association with incentive services provided by the airline (and in some cases via third-party providers/vendors). Possible travel arrangements are made with varying incentive levels. Passengers are provided a list of candidate re-accommodation plans and allowed to select the one that they prefer.

With this discussion, reference is not made to the processing associated with the incentivize manager as depicted in the FIG. 1.

At 110, the incentivize manager detects an event indicating a travel disruption to a customer of an enterprise. The types and classes of events can be configured and customized. Some events were discussed above.

According to an embodiment, at 111, the incentivize manager identifies the event as a trigger associated with one or more of: a delay in travel, a cancellation of travel, an unexpected equipment issue for the travel, and the like.

At 120, the incentivize manager applies rules in view of the event to generate a list of incentive options for re-accommodating the customer with the travel disruption. That is, the rules in combination with the events and the customer's travel itinerary are used to develop a list of incentives to purpose to the customer for selection to adjust the travel schedule. The rules can relate to a number of factors some may be event drive and some may not. Moreover, selection of the rules, overriding the rules, and augmentation of the rules can be customized.

For example, at 121, the incentivize manager augments the selection of at least some of the rules based on a profile registered to the customer.

In another case, at 122, the incentivize manager augments the selection of at least some of the rules based on a special accommodation request for the travel of the customer (handicap, food allergy, etc.).

In another scenario, at 123, the incentivize manager interacts with systems of third-party providers/vendors to at least partially generate the list (this was discussed above).

In yet another embodiment, at 124, the incentivize manager uses at least one rule that restricts the list to a current location or a destined location of the customer. So, incentive options can be tied to the present geographic position (within a configured range) of the customer or the planned (based on the travel arrangements) geographical position (within a configured range) of the customer.

In still another embodiment, at 125, the incentivize manager overrides a number of the rules based on time constraints known for the customer (using customer itinerary or travel plans).

In an embodiment, at 126, the incentivize manager makes some incentive options in the list more lucrative to the customer over other incentive options in an attempt to get the customer to be more likely to pick those more lucrative incentive options. Here, the preferences of the customer can be used to not only satisfy the consumer with desired incentives but to also make the business of the enterprise more profitable when the customer selects alternative travel arrangements that the enterprise would like to see occur.

At 130, the incentivize manager communicates the list directly or indirectly to the customer for selecting one or more of the inventive options from the list. This too can occur in a variety of manners.

For example, at 131, the incentivize manager directly presents the list to a software agent (discussed below with reference to the FIG. 2) that processes on a mobile device of the customer so that the customer can select one or more incentive options from the list on the mobile device of the customer via the software agent. The mobile device can be a phone, a laptop, a tablet, a wearable processing device, and the like.

In another case, at 132, the incentivize manager directly presents the list to a software agent (FIG. 2 below) that processes on a kiosk for selection by the customer of desired incentive options from the list using the kiosk that processes the software agent.

In yet another situation, at 133, the incentivize manager indirectly presents the list to the customer via a POS terminal manned by a human agent of the enterprise.

According to an embodiment, at 140, the incentivize manager electronically causes selective incentive options made by the customer to be delivered electronically to a mobile device of the customer. The electronic incentives may be redeemed directly from the mobile device with the service providers associated with those incentives.

In an embodiment, at 150, the incentivize manager automatically adjusts travel arrangements for the customer based on the selected incentive options.

FIG. 2 is a diagram of another method 200 for adaptive reservation processing, according to an example embodiment, according to an example embodiment. The method 200 (hereinafter “incentivize agent”) is implemented as instruction and programmed within memory and/or on a non-transitory computer-readable (processor-readable) storage medium that executes on one or more processors of a network-based machine or standalone machine; the processors of the machine are specifically configured to execute the incentivize agent. The incentivize agent may also be operational over a network; the network is wired, wireless, or a combination of wired and wireless.

The processing of the incentivize agent reflects enhanced and different aspects of the incentivize manager represented by the method 100 of the FIG. 1. That is, the incentive agent provides processing from the perspective of a device that receives the incentives provided by the incentivize manager of the FIG. 1. That device, can be one owned by the customer or one owned and/or operated by the enterprise offering the incentives via the incentivize manager.

At 210, the incentivize agent receives a list of available incentives, which are received from an incentive manager to re-accommodate a customer having a travel disruption. An example incentive manager was presented above with respect to the method 100 of the FIG. 1.

In an embodiment, at 211, the incentivize agent identifies a plurality of different service providers/vendors associated with the list. That is, multiple providers can offer incentives from the list.

At 220, the incentivize agent acquires a selection for one or more of the available incentives from the customer.

At 230, the incentivize agent causes the selection to be delivered to the customer.

For example, at 231, the incentivize agent instructs one or more service providers to directly supply specific incentives from the list to be delivered to the customer based on the customer forced travel changes.

According to an embodiment, at 240, the incentivize agent interacts with the incentive manager to adjust travel arrangements for the customer based on the selection.

In another case, at 250, the incentivize agent can be processed on one or more of: a phone of the customer, a tablet of the customer, a laptop of the customer, a wearable processing device of the customer, a kiosk, a POS terminal, and the like.

FIG. 3 is a diagram of an adaptive reservation system 300, according to an example embodiment. The components of the adaptive reservation system 300 are implemented as executable instructions and programmed within memory and/or on a non-transitory computer-readable (processor-readable) storage medium that execute on one or more processors of a network-based server (cloud, proxy, Virtual Machine (VM), etc.) or a standalone machine (client device (laptop, tablet, computer, Point-Of-Sale (POS) terminal, and the like), cashier-manned checkout station, self-service checkout station, kiosk, etc.); the processors are specifically configured to execute the components of the adaptive reservation system 300. The adaptive reservation system 300 may also be operational over a network; the network is wired, wireless, or a combination of wired and wireless.

The adaptive reservation system 300 includes an incentivize manager 301.

The adaptive reservation system 300 includes a one or more network-based or standalone machine processors, which are accessible over a network connection. The one or more processors include execution instructions for the incentivize manager 301, which resides and is programmed within memory and/or on a non-transitory computer-readable storage medium and processed on the one or more processors. Example processing associated with the incentivize manager 301 was presented in detail above with reference to the FIGS. 1 and 2.

The incentivize manager 301 is configured to detect travel disruptions to customers based on events and further configured to generate a list of available incentives for the customer to select from. Moreover, the list is communicated to an incentivize agent 302 where the customer makes a selection for one or more of the available incentives.

According to an embodiment, the server having the incentivize manager 301 is a cloud-processing environment, and the incentivize agent 302 processes on a mobile device (phone, tablet, laptop, wearable device, etc.) operated by the customer.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A processor-implemented method programmed in a non-transitory processor-readable medium and to execute on one or more processors of a machine configured to execute the method, comprising:
detecting, at the machine, an event indicating a travel disruption to a customer of an enterprise;
applying, via the machine, rules in view of the event to generate a list of incentive options to re-accommodate the customer with the travel disruption; and
communicating, via the machine, the list directly or indirectly to the customer for selecting one or more of the incentive options from the list.

2. The method of claim 1, wherein detecting further includes identifying the event as a trigger associated with one of: a delay in travel, a cancelation of travel, and unexpected equipment issues associated with travel.

3. The method of claim 1, wherein applying further includes augmenting selection of at least some of the rules based on a profile registered to the customer.

4. The method of claim 1, wherein applying further includes augmenting selection of at least some of the rules based on a special accommodation request associated with travel of the customer.

5. The method of claim 1, wherein applying further includes interacting with systems of third-party providers to at least partially generate the list.

6. The method of claim 1, wherein applying further includes using at least one rule that restricts the list to a current location or a destined location of the customer.

7. The method of claim 1, wherein applying further includes overriding a number of the rules based on time constraints known for the customer.

8. The method of claim 1, wherein applying further includes making some incentives in the list more lucrative to the customer over other incentives in an attempt to get the customer to be more likely to pick those more lucrative incentives.

9. The method of claim 1, wherein communicating further includes directly presenting the list to a software agent processing on a mobile device of the customer for selection by the customer on the mobile device via the software agent.

10. The method of claim 1, wherein communicating further includes directly presenting the list to a software agent processing on a kiosk for selection by the customer on the kiosk via the software agent.

11. The method of claim 1, wherein communicating further includes indirectly presenting the list to the customer via a Point-Of-Sale (POS) terminal manned by a human agent of the enterprise.

12. The method of claim 1 further comprising, electronically, via the machine, causing selected incentive options made by the customer to be delivered electronically to a mobile device of the customer.

13. The method of claim 12 further comprising, automatically, via the machine, adjusting travel arrangements for the customer based on the selected incentive options.

14. A processor-implemented method programmed in a non-transitory processor-readable medium and to execute on one or more processors of a machine configured to execute the method, comprising:
receiving, at the machine, a list of available incentives received from an incentive manager to re-accommodate a customer having a travel disruption;
acquiring, at the machine, a selection for one or more of the available incentives for the customer; and
causing, from the machine, the selection to be delivered to the customer.

15. The method of claim 14 further comprising, interacting, via the machine, with the incentive manager to adjust travel arrangements for the customer based on the selection.

16. The method of claim 14 further comprising, processing the method on one of: a phone of the customer, a tablet of the customer, a laptop of the customer, a wearable processing device of the customer, a kiosk, and a Point-Of-Sale (POS) terminal.

17. The method of claim 14, wherein receiving further includes identifying a plurality of different service providers associated with list.

18. The method of claim 14, wherein causing further includes instructing one or more service providers to directly supply specific incentives from the list to be delivered to the customer.

19. A system comprising:
memory having an incentive manager that executes on the processors of a server; and
wherein the incentive manager is configured to detect travel disruptions to customers based on events and further configured to generate a list of available incentives for the customer to select from, the list communicated to an incentive agent where the customer makes a selection for one or more of the available incentives.

20. The system of claim 19, wherein the server is a cloud-processing environment, and the incentive agent processes on a mobile device operated by the customer.
